(19) United States
(12) Patent Application Publication
(10) Pub. No.: US 2014/0115075 A1
(43) Pub. Date: Apr. 24, 2014

(54) Communicator program manager

(71) Applicant: Michael D. Rossman, Phoenix, AZ (US)

(72) Inventor: Michael D. Rossman, Phoenix, AZ (US)

(21) Appl. No.: 13/986,960

(22) Filed: Jun. 19, 2013

Related U.S. Application Data
(63) Continuation-in-part of application No. 13/066,154, filed on Apr. 6, 2011, now abandoned.
Application No. 13/066,154 is a continuation-in-part of application No. 11/966,430, filed on Dec. 28, 2007, now abandoned.
(60) Provisional application No. 60/882,474, filed on Dec. 28, 2006.

(51) Int. Cl. H04L 12/58

(52) U.S. Cl. CPC H04L 51/24
USPC 709/206

(57) ABSTRACT

A secure communication system including a first central server connected to the Internet to transmit messages over the Internet utilizing IP protocol; at least one push device with a display screen; at least one pull device commonly owned with the push device; at least one cell phone tower to receive a push alert message and transmit the push alert message to the push device for display on the display screen of the push device; a vendor server connected to the Internet and in communication with the cell tower to receive an alert message generated by the first central server and generate a push alert message to transmit to the cell tower for transmission to the push device to appear on the display screen of the push device; and, a channel architecture on the first central server comprising a plurality of different channels.

This application is a continuation in part of U.S. patent application Ser. No. 13/066,154, filed Apr. 6, 2011, which is a continuation of U.S. patent application Ser. No. 11/966,430, filed Dec. 28, 2007, which claims priority based on U.S. provisional patent application Ser. No. 60/882,474, filed Dec. 28, 2006.

This invention relates generally to the field of program management. More particularly, the invention relates to a method and apparatus for managing communicator programs.

Programs can be run on a computer to receive information over the Internet and present that information on a computer display. Specialized programs may retrieve and display news and other information related to a specific interest, such as a particular sports team.

These and other features, aspects, and advantages will become better understood with regard to the following description, appended claims, and accompanying drawings where:

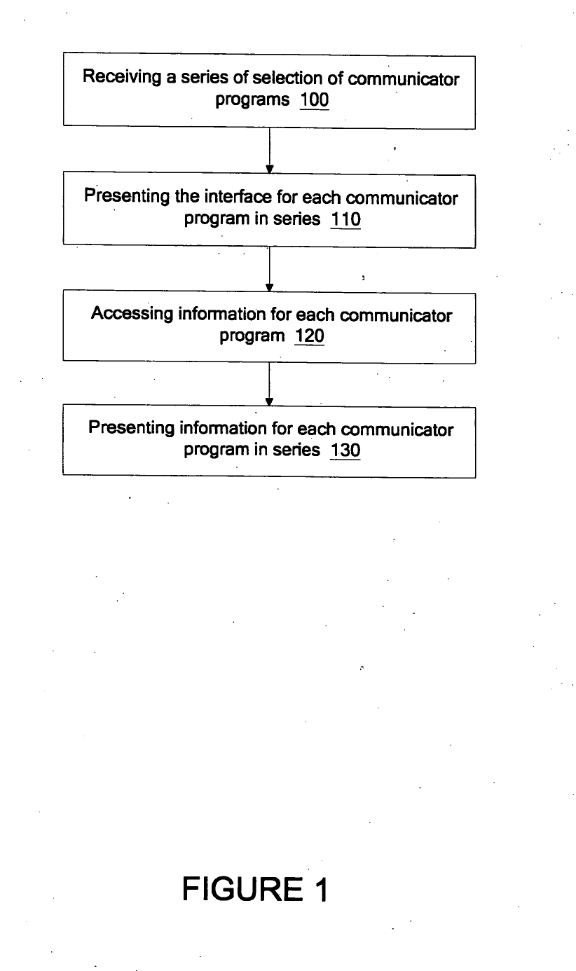

FIG. 1 illustrates a flow chart of a method according to one embodiment;

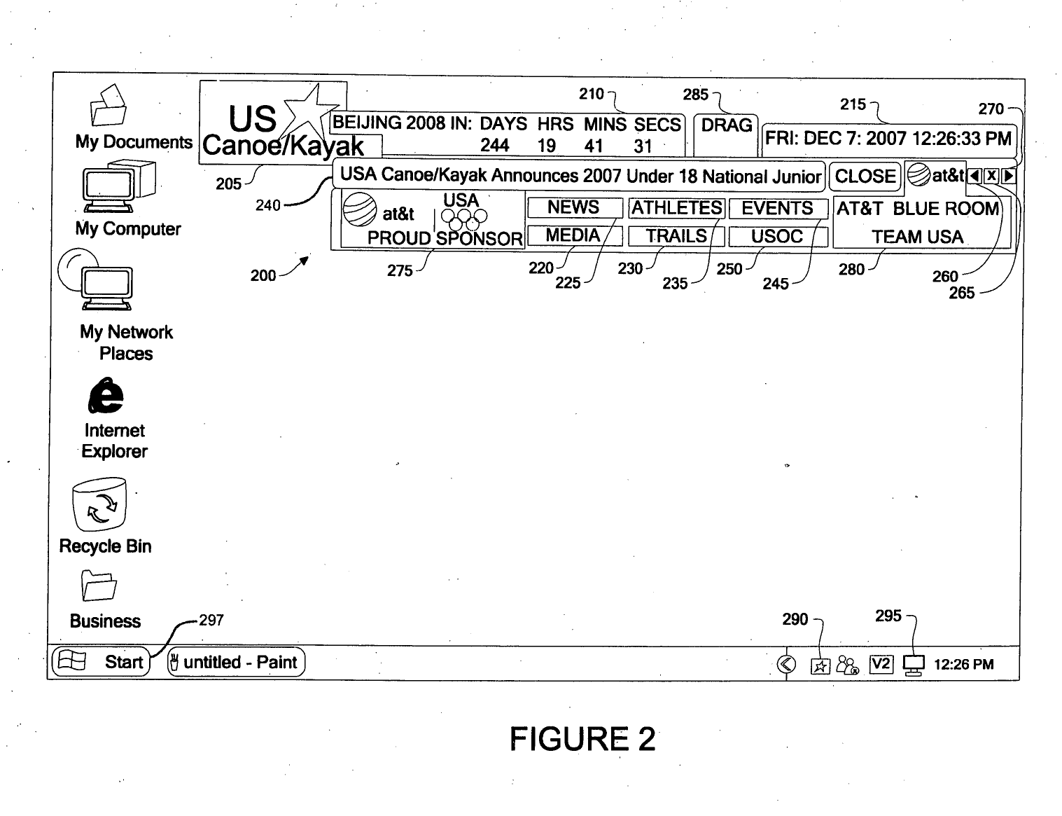

FIG. 2 illustrates a screen shot of a communicator interface according to one embodiment;

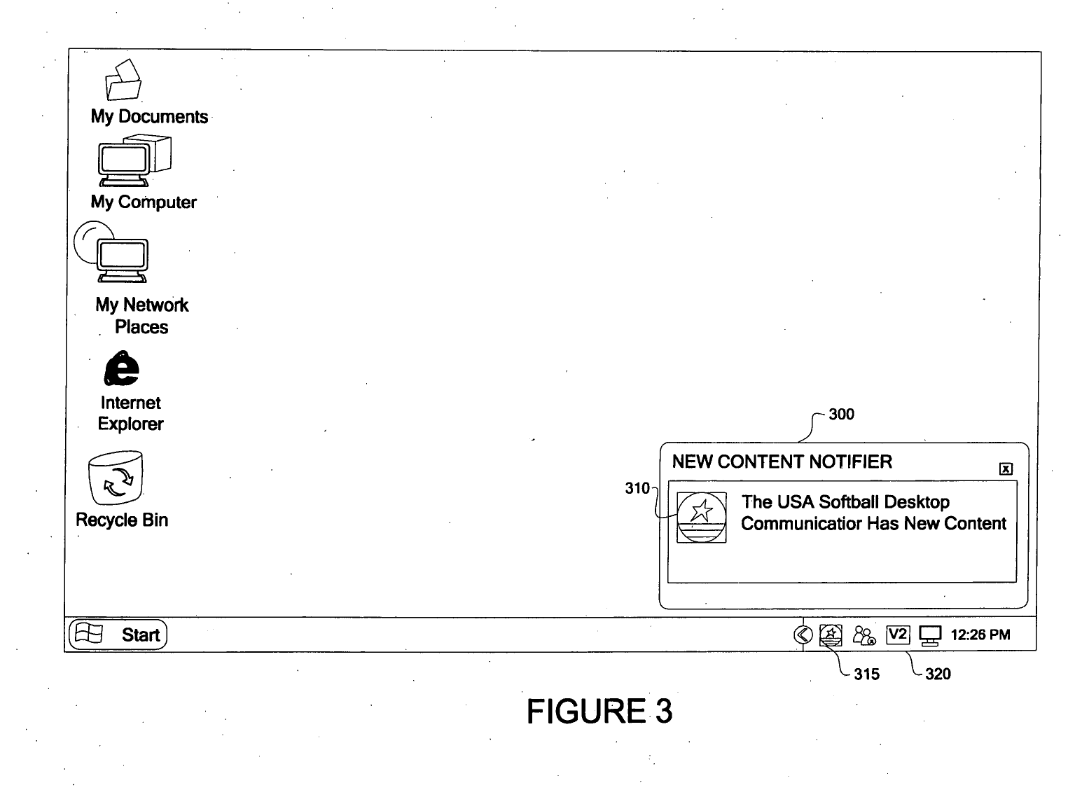

FIG. 3 illustrates one embodiment of a screen shot of the alert window of the communicator program manager;

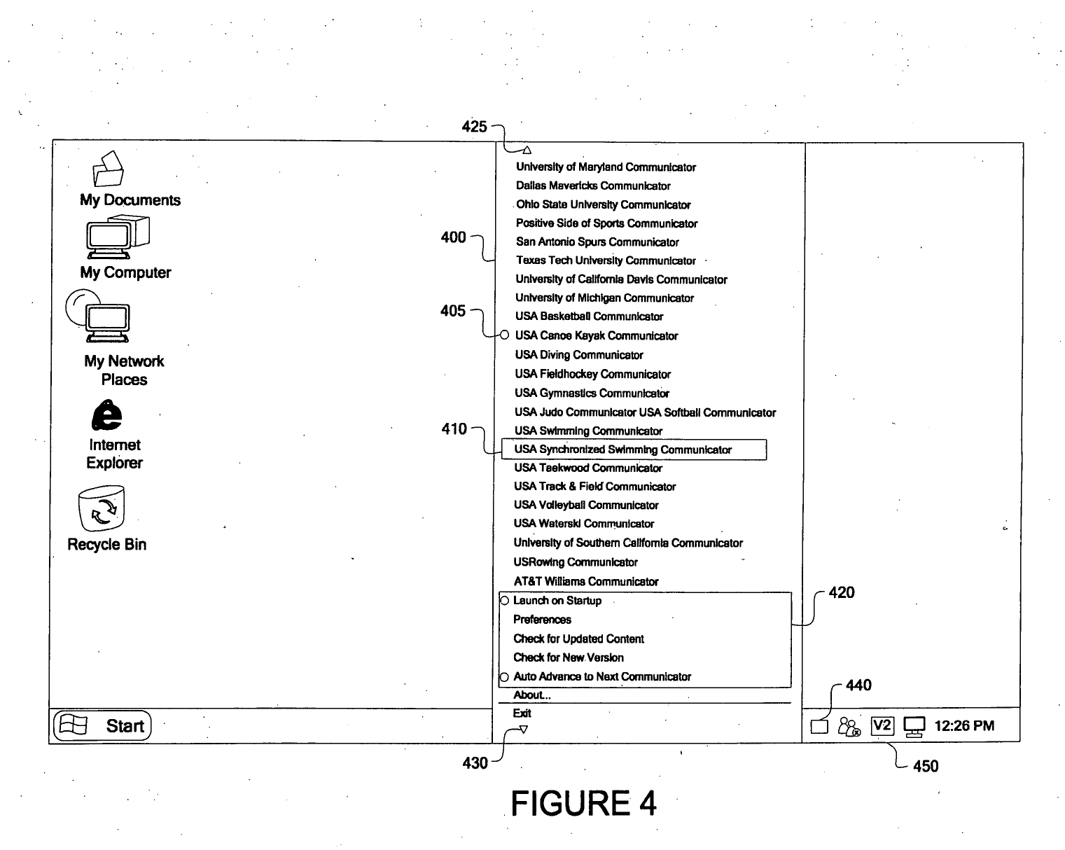

FIG. 4 illustrates one embodiment of a screen shot of a drop-down list;

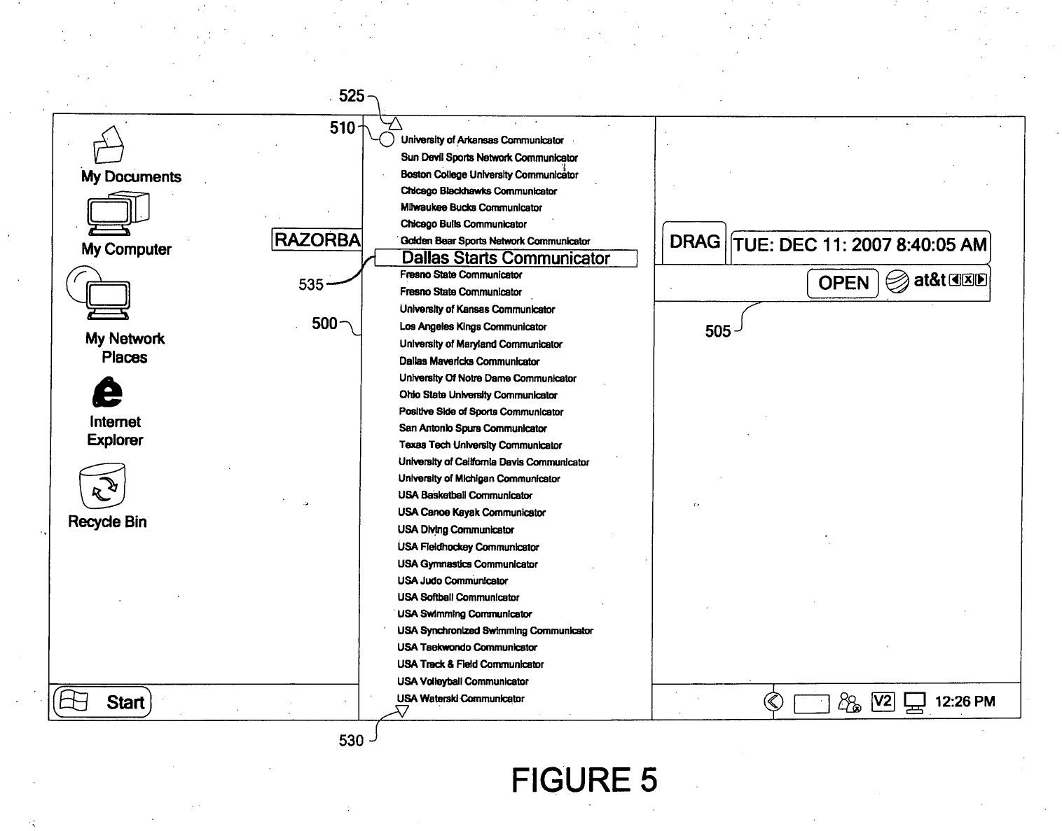

FIG. 5 illustrates a screen shot of a drop-down list;

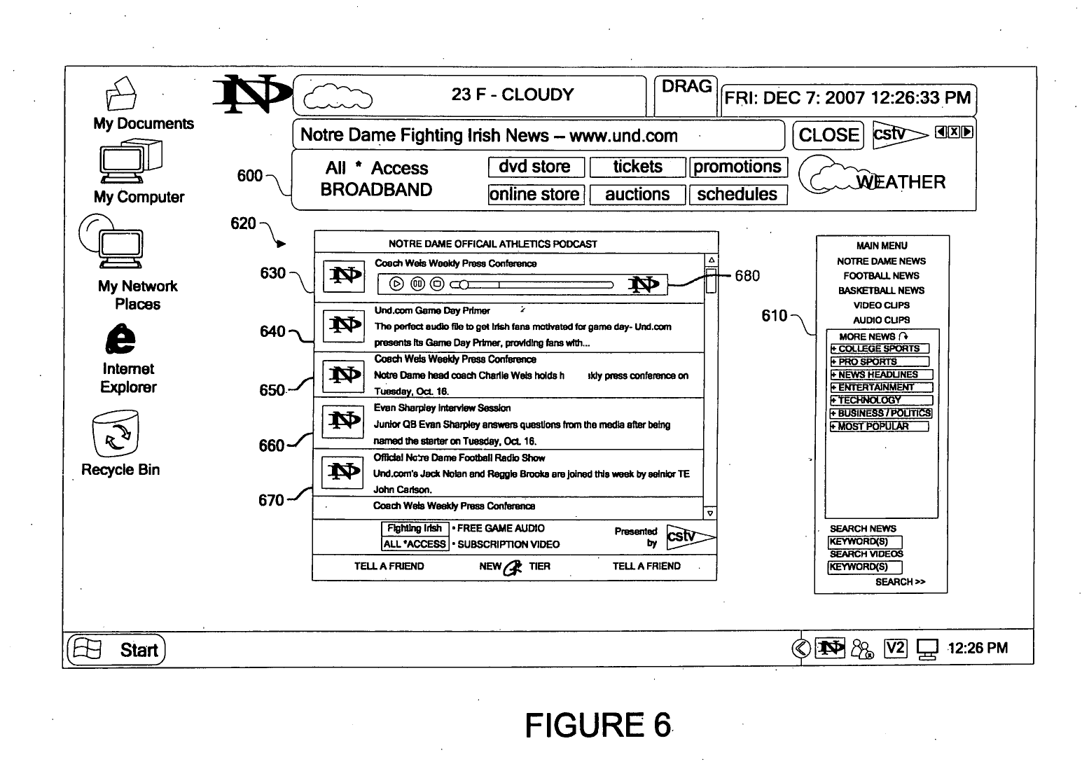

FIG. 6 illustrates another embodiment of a communicator interface;

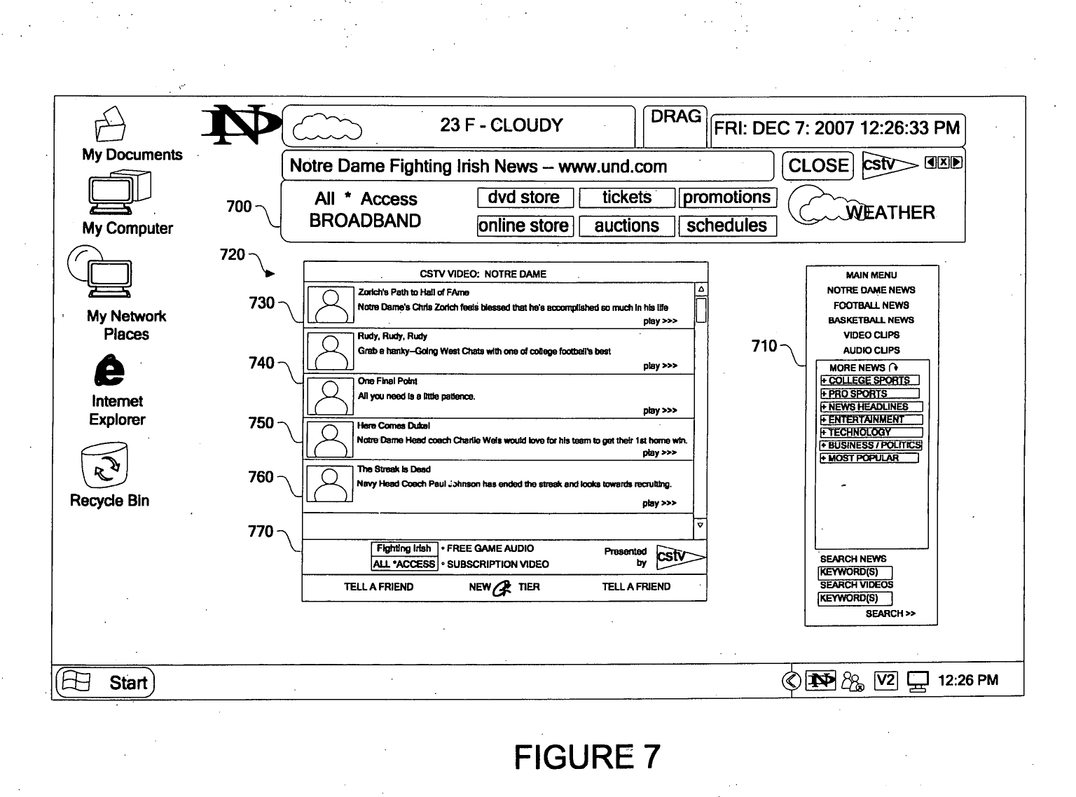

FIG. 7 illustrates another embodiment of a communicator interface;

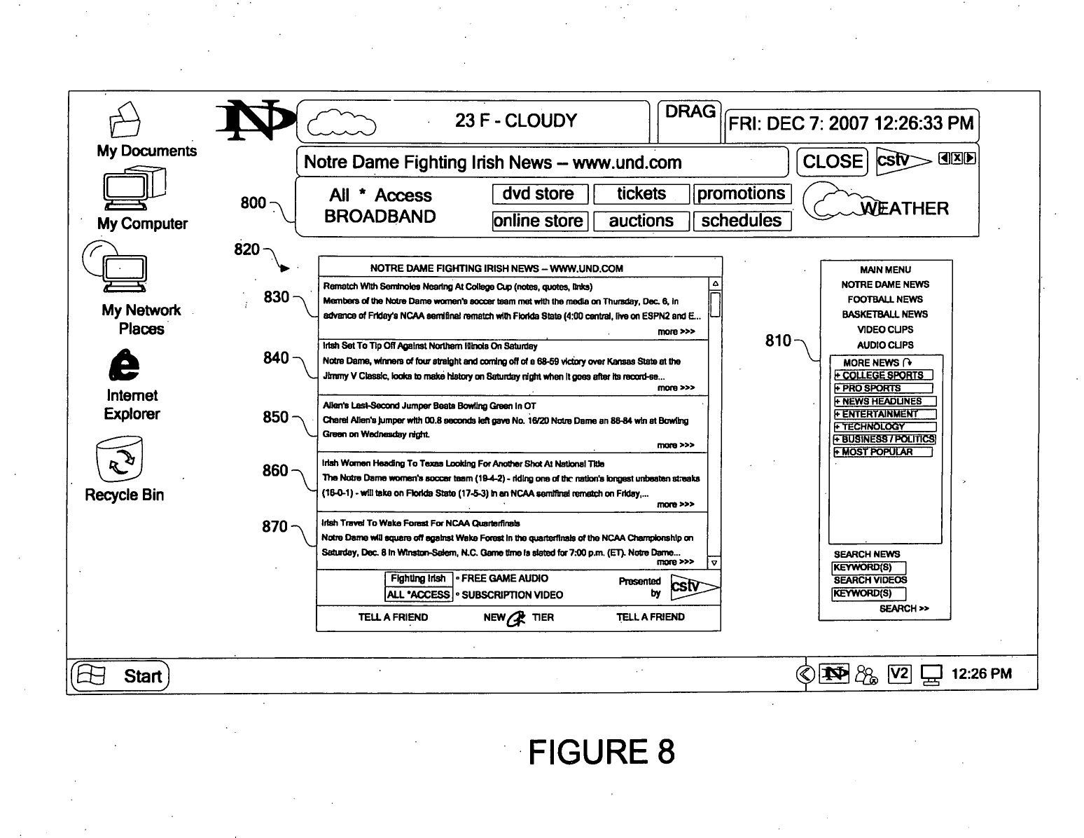

FIG. 8 illustrates another embodiment of a communicator interface;

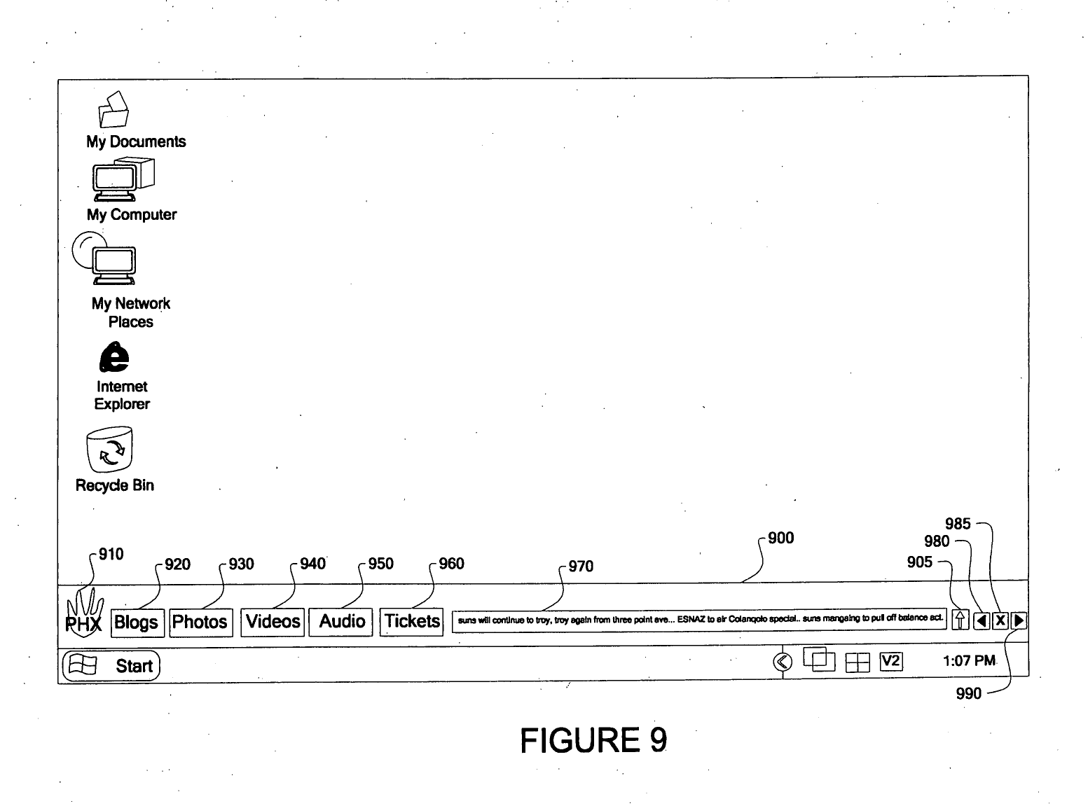

FIG. 9 illustrates another embodiment of a communicator interface;

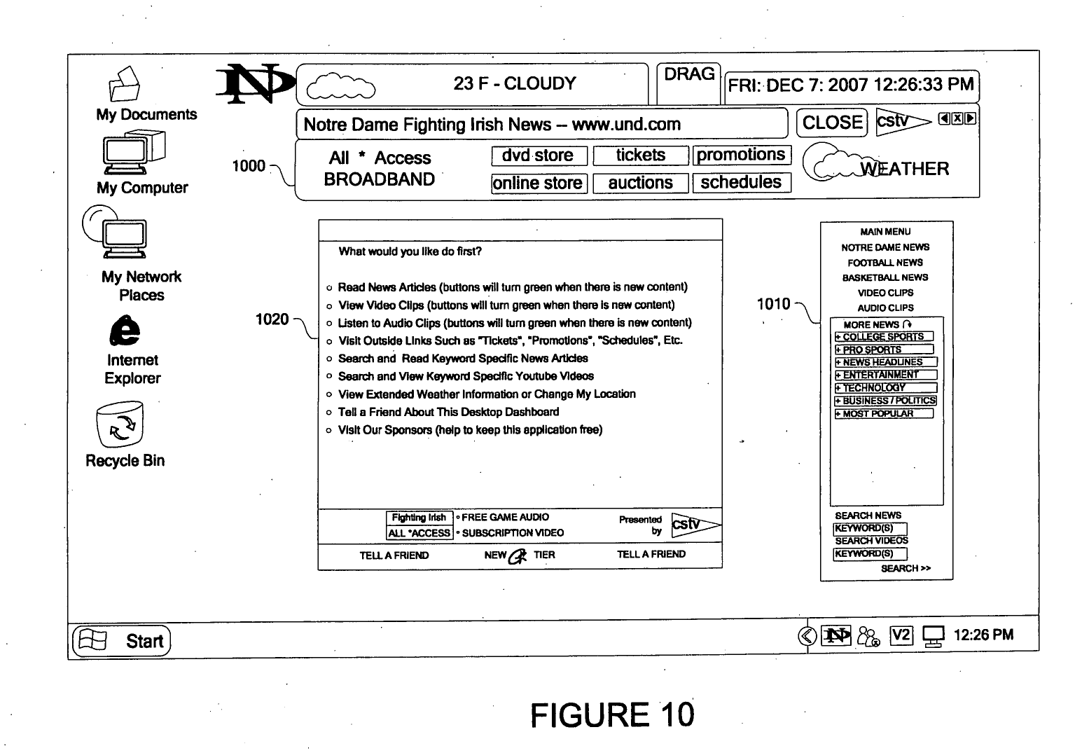

FIG. 10 illustrates another embodiment of a communicator interface;

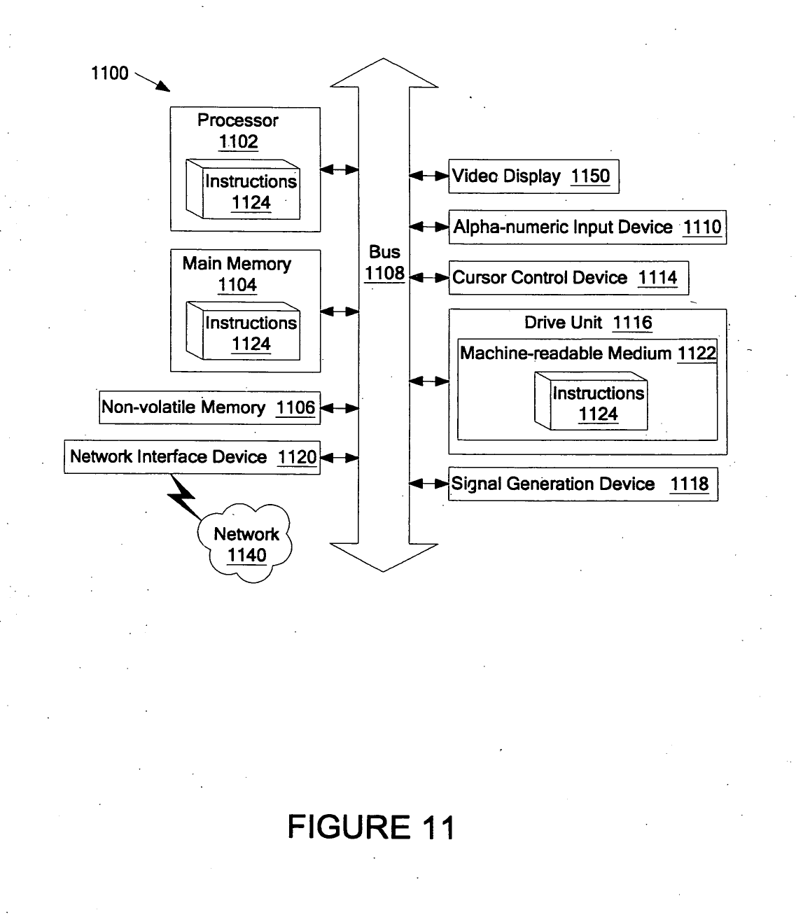

FIG. 11 is a diagrammatic representation illustrating an embodiment of a machine in the exemplary form of a computer system used to perform the method of FIG. 1;

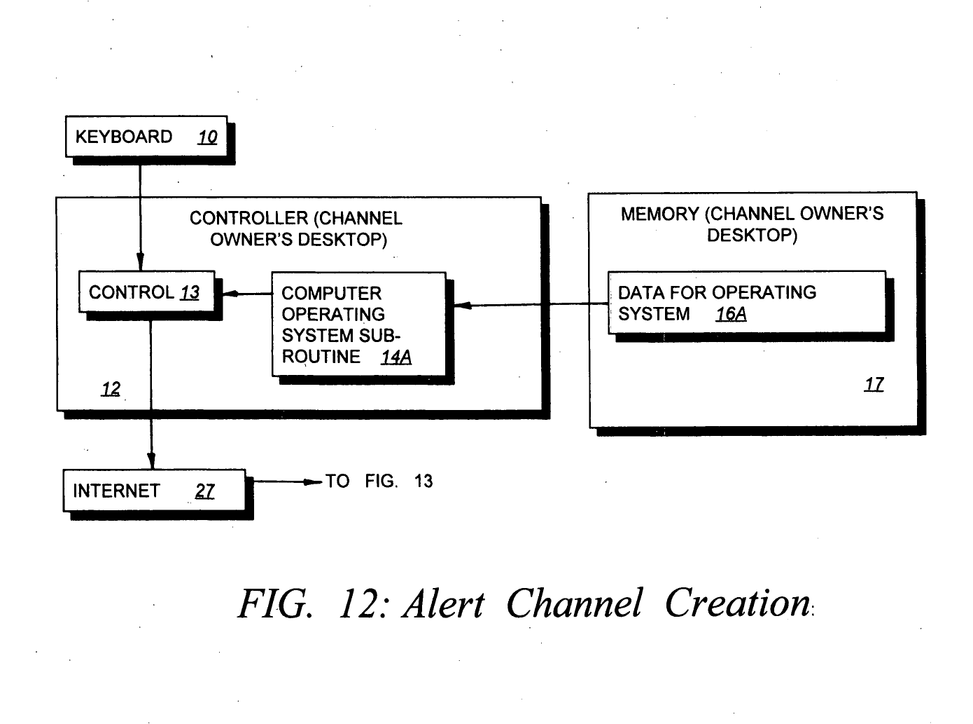

FIG. 12 is a block diagram illustrating apparatus including in part a machine in the form of a computer system used to create an alert channel at an alert central computer; and,

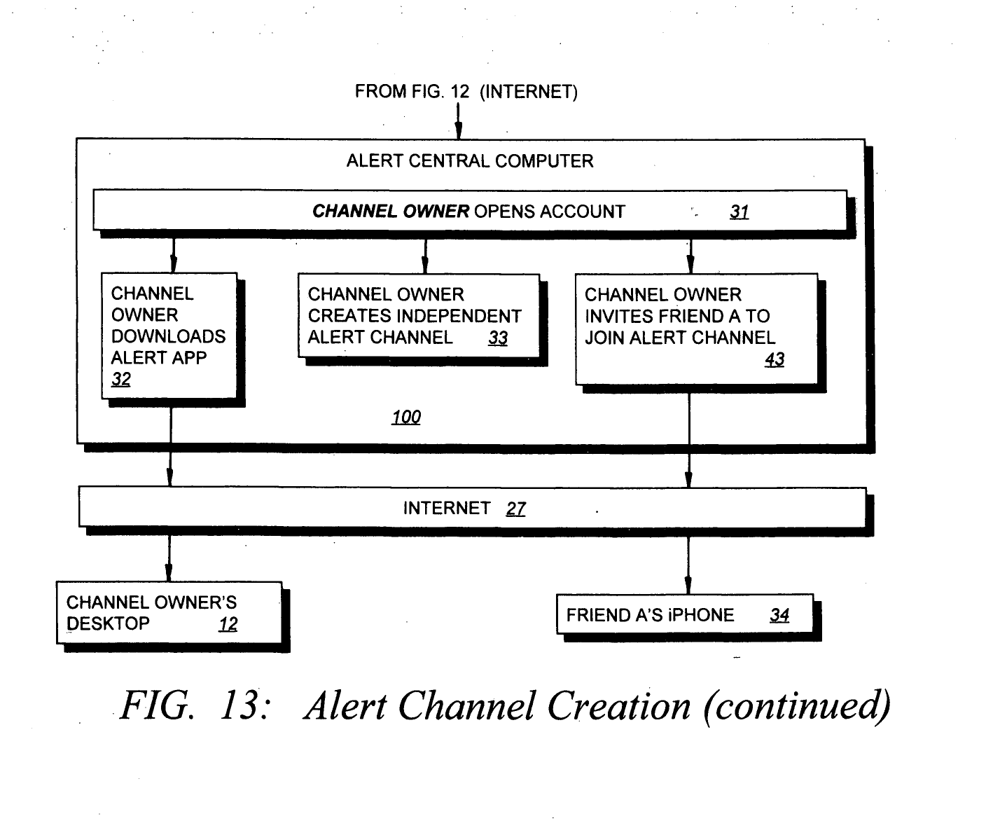

FIG. 13 is a block diagram illustrating an alert central computer utilized in conjunction with the computer system of FIG. 12 to create an alert channel at the alert central computer;

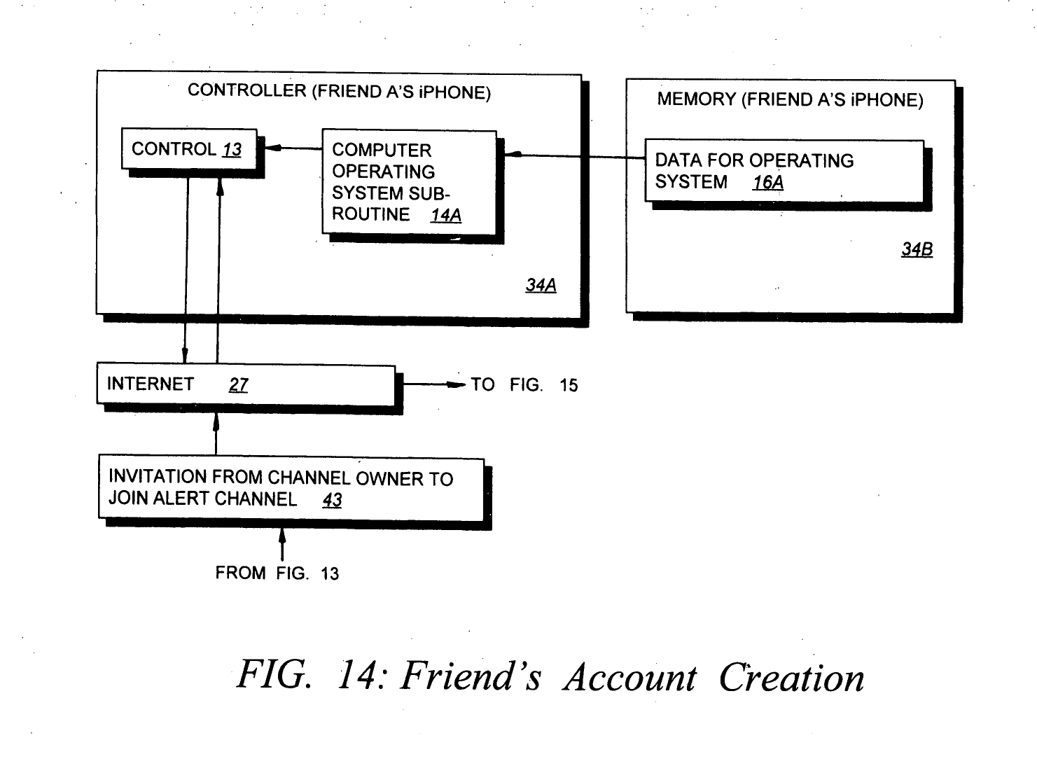

FIG. 14 is a block diagram illustrating apparatus including in part a machine in the form of a computer system used to create an account at an alert central computer and to accept an invitation to participate in an alert channel created at the central computer;

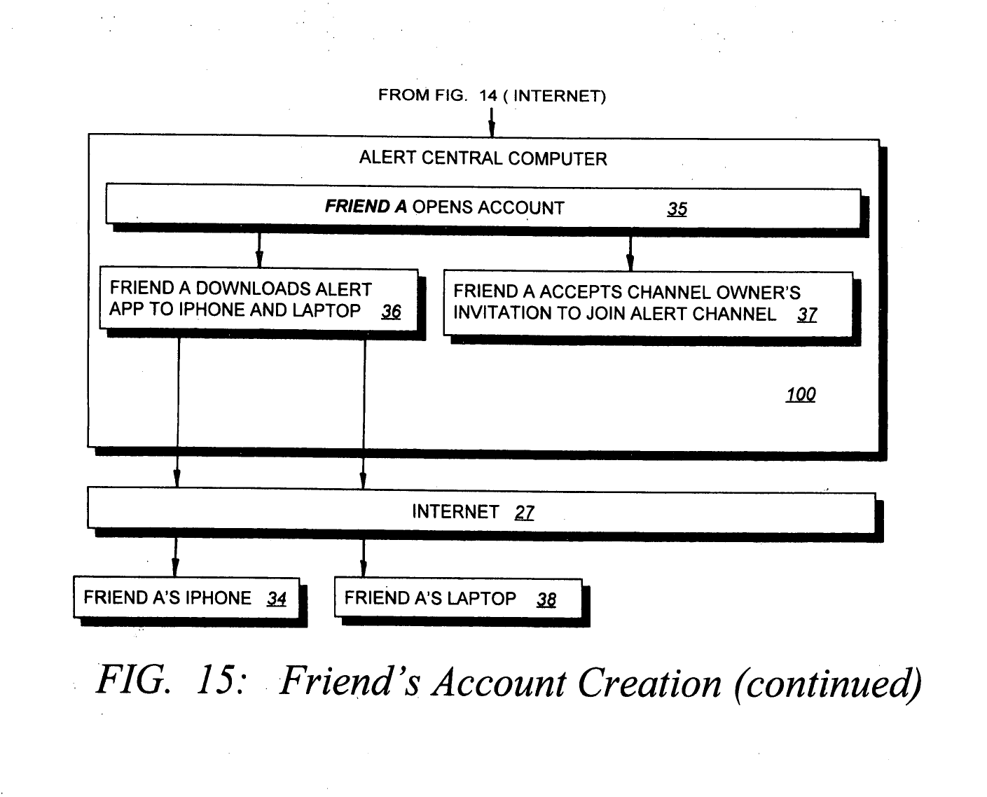

FIG. 15 is a block diagram illustrating an alert central computer utilized in conjunction with the computer system of FIG. 14 to create an account and to allow an individual to participate in an alert channel created at the central computer;

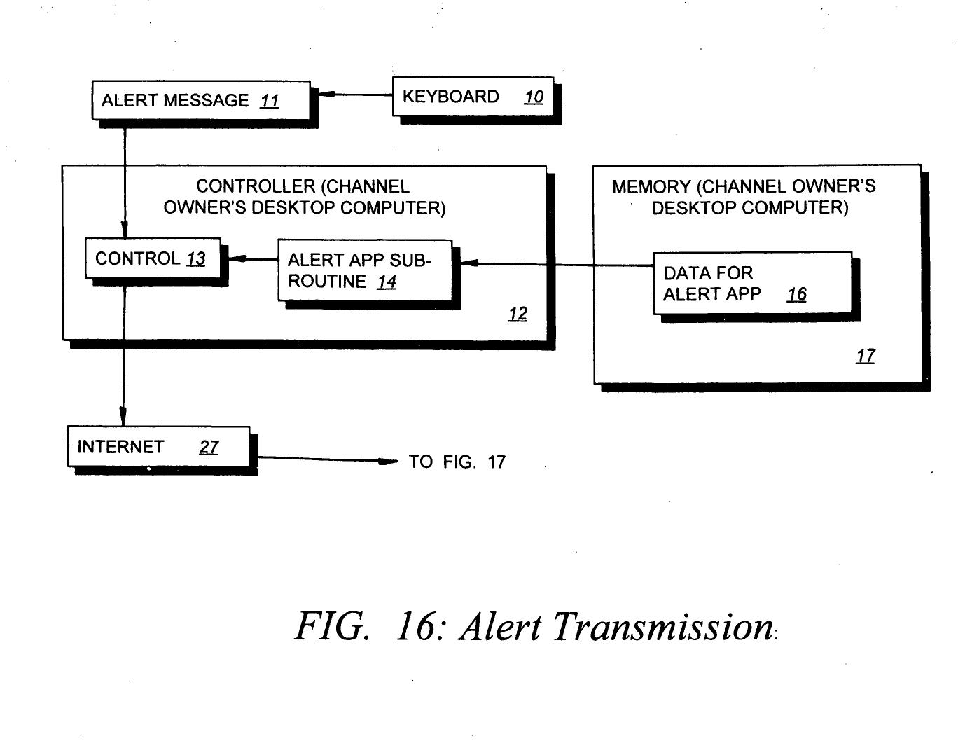

FIG. 16 is a block diagram illustrating apparatus including in part a machine in the form of a computer system used to create an alert message and transmit the message to an alert central computer; and,

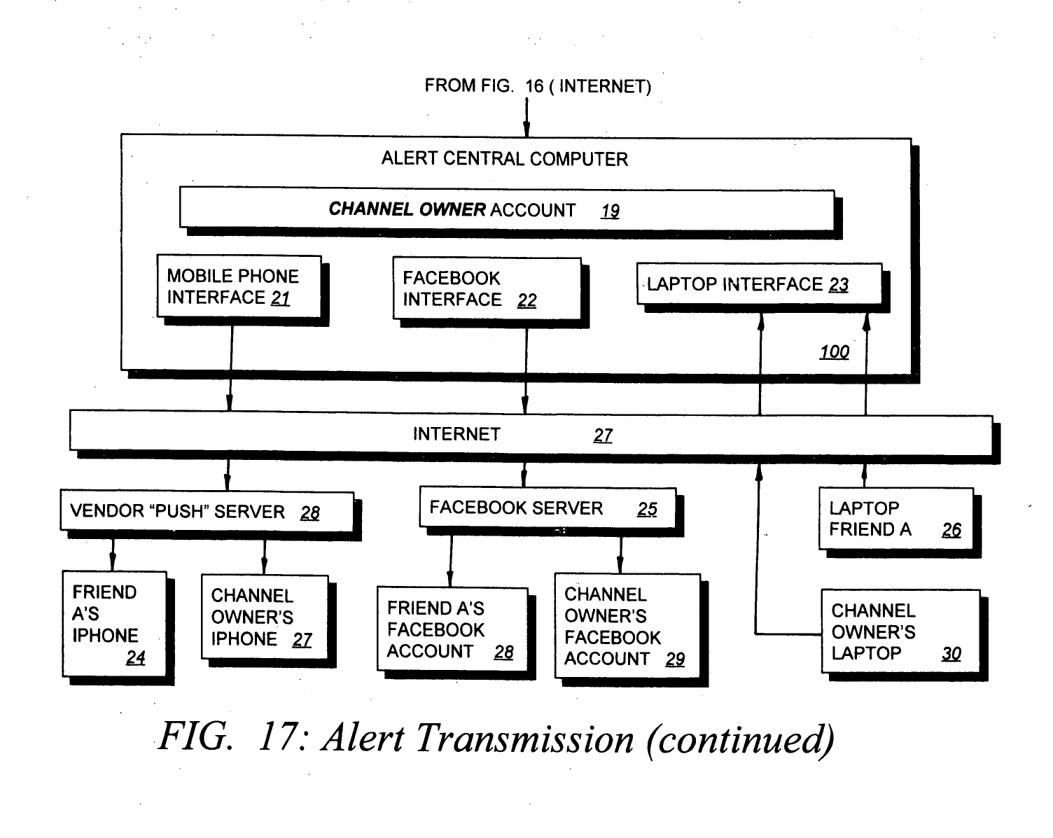

FIG. 17 is a block diagram illustrating apparatus including in part a machine in the form of an alert central computer used to transmit (or create and transmit) simultaneously an alert message to “push” and “pull” devices which are each located at separate remote locations.

Briefly, in accordance with the invention, provided is an improved method and apparatus for managing a plurality of communicator programs each having a corresponding interface, the method comprising receiving a sequence of selections of one of the plurality of communicator programs; sequentially presenting one of a plurality of communicator interfaces, each corresponding to one of the communicator programs; accessing information corresponding to each of the communicator programs; and sequentially presenting information corresponding to each of the plurality of communicator programs; the apparatus being configured to perform the method.

In another embodiment of the invention, an improved secure communication system is provided. The improved system comprises a first central server connected to the Internet to transmit messages over the Internet utilizing IP protocol; at least one push device with a display screen, the push device selected from a group consisting of mobile phones and computer tablets configured to function in part as a mobile phone; at least one pull device commonly owned with the push device, connected to the Internet and selected from a group consisting of laptop computers and desk top computers; at least one cell phone tower to receive a push alert message and transmit the push alert message to the push device for display on the display screen of the push device; a vendor server connected to the Internet and in communication with the cell tower to receive an alert message generated by the first central server and generate a push alert message to transmit to the cell tower for transmission to the push device to appear on the display screen of the push device; a channel architecture on the first central server comprising a plurality of different channels each independently created by a different subscriber, and operable independently of the other channels. At least one of the channels is a private channel that is configured to generate simultaneously a selected alert message for both the vendor server and the pull device, the selected alert message being transmitted by the first central server over the Internet using IP protocol to the vendor server and the pull device, that is non-published, that is accessible only through the first central server by the subscriber of the channel, and that is non-identifiable and non-locatable using an Internet search engine.

Turning now to the drawings, in which like reference characters to refer to corresponding elements throughout the several views, and which are presented by way of illustration, and not limitation of the invention, numerous specific details are described to provide a thorough understanding of the disclosure. However, in certain instances, well known or conventional details are not describe in order to avoid obscuring the description. References to one or an embodiment in the present disclosure can be, but not necessarily are, references to the same embodiment; and, such references mean at least one.

Reference in this specification to “one embodiment” ro “an embodiment” means that a particular feature, structure, or characteristic described in connection with the embodiment is included in at least one embodiment of the disclosure. The appearance of the phrase “in one embodiment” in various placed in the specification are not necessarily all referring to the same embodiment, nor are separate or alternative embodiments mutually exclusive of other embodiments. Moreover, various features are described which my be exhibited by some embodiments and not by others. Similarly, various requirements are described which may be requirements for some embodiments but not other embodiments.

A communicator program is a program that can be run on a computer or other processor-based machine to receive information over a network and represent that information on a computer display or by other information presentation means, such as voice-synthesized speech. Specialized communicator programs may retrieve and display information related to a specific interest, such as news for a particular sports team. For example, the communicator program may present information in the for of game broadcasts, video highlights and score updates associated with the sport team.

A user may install multiple communicator programs, each one managing the retrieval and presentation of information related to different interests or from different information sources. Each of several communicator programs may retrieve and present information related to a different sports team, for example. Each of several communicator programs may retrieve and present information related to different subjects. For example, each communicator program may download national new associated with a different country. Other communicator programs may retrieve and present information from one or more associated information sources, such as blogs or the online versions of newspapers or magazines.

A communicator program manager manages multiple communicator programs. In some embodiments, to communicator program manages the download and installation of the communicator programs and incorporates the installed communicator program in the set of communicator programs managed. In some embodiments, the communicator program manager manages the startup of one or more of the communicator programs in response to the startup of the computer or the startup of the communicator program manager. In some cases, the communicator programs are run i a background process under the control of the communicator program manager.

In some embodiments, the communicator program is configured by a user to specify a sequence of communicator programs. In some embodiments, the communicator program manager selects each of the communicator programs in the sequence specified. When a communicator program is select, a communicator interface corresponding to the communicator program is displayed and information from that communicator program is presented.

In some embodiments, the next communicator program in the sequence is selected after a predetermined time interval following the selection of the currently selected communicator program. In other embodiments, the next communicator program in the sequence is selected after information meeting a predetermined criteria is presented for the currently selected communicator program. The criteria may be all new information, all new videos, or all information containing a certain keyword, for example. In some cases, no information meeting the specified criteria is available and the communicator program manager selects a the next program in the sequence. In yet other embodiments, the subsequent communicator program is selected based on a user input specifying the subsequently selected program as being the previous or next communicator program in an ordered list of communicator programs.

FIG. 1 illustrates a flow chart of a method according to one embodiment.

In process 100, a sequence of selections of communicator programs are received. In some embodiments, the sequence can be specified based on the order in which the communicator programs were installed on a computer. This ordered list may be used as the default sequence that can be modified based on user input, for example.

In some embodiments, the user can specify the sequence by generating an ordered list of communicator programs. For example, the user may drag-and-drop the names of communicator programs in a list to specify the order. In some embodiments, the ordered list of communicator programs is followed in sequence and wraps around to the first communicator program after the last communicator program i the list is selected. This ordered list may be used as the default sequence that can be modified based on user-input, for example.

In some embodiments, the user interacts with a user interface having a previous button and a next button. The sequence can be specified on-the-fly by clicking on the previous button or the next button in the user-interface In response to clicking the previous button, the communicator program immediately preceding the currently selected communicator program in the ordered list is selected. In response to clicking the next button, the communicator program immediately following the currently selected communicator program in the ordered list is selected. In some embodiments, the sequence wraps around such the first communicator program in the ordered list immediately follows the last communicator program and the last communicator program in the ordered list immediately precedes the first communicator program.

In some embodiments, the sequence can be specified on-th-fly by selecting the next communicator program form a drop-down list of communicator programs. Other methods of selecting the next communicator program in the sequence may be used. For example, speech recognition technology may be used to recognize the names of one of the communicator programs.

In some embodiments, the sequence of communicator programs can be specified by a combination of one or more methods of selecting communicator programs. For example, a sequence maybe specified by ordering a list of communicator programs. After automatically sequencing through a few communicator programs int at ordered list, the user may click the previous button to select the preceding communicator program in the ordered list, and then specify the subsequent communicator program by selecting a communicator program from a drop-down list. In some embodiments, each subsequent communicator program in the sequence is selected automatically after a predetermined time interval.

In process 110, the interface for each communicator program is presented according to the sequence of communicator programs. In some embodiments, the interface includes a logo or other identified specifying the subject matter of information source associated with the communicator program. In some embodiments, the communicator program interfaces include buttons to specify the sequence of communicator programs according to one or more of the methods described herein. In some embodiments, the communicator program interlaces include menu buttons to select one of several categories of information available for presentation by the communicator program. For example, the categories may be based on media type, such as text, video, an audio, and on subject matter.

In process 120, the information for each communicator program is accessed. In some embodiments, the information is accessed using an RSS (know as Resource Descriptive Framework (RDF) Site Summary or Really Simple syndication) feed. The communicator program subscribes to an RSS fee using a universal resource locator (URL) to specify the information source. The communicator program regularly checks the RSS feed for new information, such a news headlines, blog entries, streaming audio, streaming video and podcasts. The RSS feed may also be used to access information in other RSS-compatible formats.

In some embodiments, the information is accessed using other methods. In some embodiments, the communicator program retrieves information by periodically checking information sources. In other embodiments, the communicator program receives information transmitted by the information sources when the information source has new information. In some embodiments, information is retrieved for a communicator program in response to the communicator program being selected by the communicator program manager. In other embodiments, the communicator program checks the information sources and retrieves information in the background even when that communicator program is not selected.

In process 130, some or all of the retrieved information is presented for each communicator program according to the sequence of communicator programs. In some cases, a predetermined criteria is used to select the information presented. For example, the information may be information posted within a certain period of time or information containing a certain keyword or information of a certain type, such as streaming video. In some embodiments, the information for each communicator program is selected by the user using a menu in the corresponding communicator interlace. For example, the user may select text-based news, streaming video broadcasts or streaming audio broadcasts.

In some embodiments, the information from each program is presented through a single interface in sequence according to the sequence of communicator programs. For example, new text-based information, if any, from each communicator program may be appended in sequence in a ticker display. FIG. 2 includes an example of a ticker display. In other embodiments, video streams of new information, if any, from each communicator program may be appended in sequence in a video display. Similarly, audio streams may be sequenced.

In some embodiments, the communicator interlace changes to correspond to the associated communicator program as information from subsequent communicator programs is displayed. In other embodiments, the information is presented independent of the communicator program and the communicator interface does not change as the presentation of sequenced information transitions through portions associated with different communicator programs.

In some embodiments, the subsequent communicator program in the sequence is selected automatically after some or all of the information for the currently selected communicator program is presented. For example, the information may be all the information available for the currently selected communicator program, all the new information available for the currently selected communicator program, or all the information meeting some criteria, such as containing a particular keyword, for the currently selected communicator program.

FIG. 2 illustrates a screen shot of a communicator interface according to one embodiment.

In one embodiment, a communicator interface 200 for a communicator program includes a previous button 250 and a next button 270. The communicator interface 200 also includes a logo display 205, a countdown timer display 210, a date-and-time display 215, a ticker display 240, a menu button 245, a menu button 250, a close button 255, a close button 265, a sponsor display 275, a sponsor display 280, and a drag button 285. A communicator task bar icon 290 is included in a task bar area 295.

The previous button 260 and the next button 270 can be used to control the sequence of communicator programs. In response to clicking the previous button 260, the communicator program immediately preceding the currently selected communicator program in the ordered list is selected. In response to clicking the next button 270, the communicator program immediately following the currently selected communicator program in the ordered list is selected. In some embodiments, the sequence wraps around such that the first communicator program in the ordered list immediately follows the last communicator program and the last communicator program in the ordered list immediately precedes the first communicator program.

The logo display 205 can be used to display the logo associated with the information presented through the communicator program. For example, the logo display 205 may include the trademark image associated with a sports team for a communicator interface configured to present news and information related to that sports team. In the illustrated embodiment, the logo display 205 includes a logo for USA Canoe/Kayak. Information presented may include news related to canoe and kayak racing in the United States.

In some embodiments, the information is associated with other organizations, such as a particular company, professional association, political organization or special interest group, and the logo display 105 includes a logo associated with the organization. In other embodiments, the information is associated with a particular subject matter such as nanotechnology, venture capital or corporate law, and the logo display 105 is a generic description of the information category. Other classifications and categorizations of information may be used and the information may be associated with one or more organizations or information sources.

In some embodiments, the communicator task bar icon 290 is displayed in the task bar area 290 with an image associated with the currently selected communicator program. In some embodiments, the task bar icon 290 can be selected to access the communicator program associated with the currently displayed image. In other embodiments, the communicator program can be selected to access the communicator program manager to present a drop-down list of all communicator programs, for example. In some embodiments, the communicator task bar icon 290 does not change when another communicator program is selected.

In the illustrated embodiment, the countdown timer display 210 includes a countdown time to the 2008 Beijing Olympics, which may include canoe and kayak competitions. In other embodiments, the countdown timer display 210 may be used to countdown times related to other events. For example, the countdown timer 210 may be used to display the time to the next game for a sports team, the time to the next meeting for a professional association, or the time to the next election for a political organization. In some embodiments, the countdown time may be used to determine the information that is relevant for presentation by the communicator interface.

In the illustrated embodiment, the date-and-time display 215 includes the current date and time. In some embodiments, the date and time is the local time in the time zone of the computer presenting the communicator interface 200. In other embodiments, the date and time is the local time in the time zone relevant to the information presented in the communicator interface 200. For example, in a communicator interface presenting information about a sports tea based in New York City, the date and time presented may be for New York City even though the communicator interface is being presented on a computer based in Japan. In some embodiments, the date and time may be used to determine the information that is relevant for presentation by the communicator interface.

In the illustrated embodiment, the ticker display 240 displays a portion of text announcement for the organization. In some embodiments, the text is short enough to display it completely without scrolling in the ticket display 240. In other embodiments, the text scrolls across the ticker display 240 to present the text from beginning to end a portion at a time.

In the illustrated embodiment, six menu buttons are presented. The menu buttons may be used to select various categories of information for presentation. In some cases, one or more additional menus are presented after selecting a menu button. For example, the menu button 220 is labeled “Media.” A sub-menu of specific streaming videos may be presented after selecting the menu button 220. The user may the select one of the streaming videos for presentation. The menu button 225 is labeled “News.” A sub-menu of specific text-based news articles may be presented after selecting the menu button 225. The user may then select a specific news article for presentation.

In other embodiments, more or less menu buttons may be used to organize and select categories of information available for presentation by the communicator interface 200. Information may be presented in many forms including text, images, streaming audio, and streaming video. In some embodiments, well-know standards, such as Joint Photographic Experts Group (JPEG) and Motion Picture Experts Group 4 (MPEG 4), are used to represent the information. Other information types and other representation methods may be used.

The close button 255 and the close button 265 are used to close the communicator interface 200. When either close button is selected, the communicator interface 200 is removed from the display. In some embodiments, the communicator interface 200 can be displayed again by clicking on the communicator task bar icon 290 in the task bar area 295. In other embodiments, the communicator interface 200 can be opened using a start button 297 and selecting the communicator program from a list of programs. A drag button 285 can be used to position the communicator interface 200 by clicking on the drag button 285 and dragging the communicator interface 200 to the desired location on the display.

The sponsor display 275 and the sponsor display 280 present sponsorship information. Sponsors may pay for the right to present their logo on the communicator interface 200. In some embodiments, sponsorship may change periodically and these displays may be updated with new displays from the same or different sponsors. In some embodiments, the display is static. In other embodiments, the display can be animated using Adobe Flash, for example.

In some embodiments, the information is accessed using one or more RSS feeds. The communicator program regularly checks the RSS information feed for new information, such as news headlines, blog entries, streaming audio, streaming video and podcasts. The RSS feed may also be used to access information in other RSS-compatible formats. Other formats may be used.

In some embodiments, the information may include an information alert. The information alert may include information that should be presented immediately. For example, the alert may indicate breaking news or other notable events, such as the beginning of a sporting event or professional meeting for an organization associated with that communicator program. In some embodiments, the communicator program manager monitors the communicator programs for information alerts and presents the information associated with information alerts in an alert window.

FIG. 3 illustrates one embodiment of a screen shot of an alert window.

An alert window 300 displays a heading “New Content Notified.” In some embodiments, the alert window 300 displays some or all of the new information associated with the alert. The alert window 300 also indicates the communicator program that has received an alert. For example, the alert window may include a logo display 310 corresponding to the associated communicator program. A logo task bar display 315 in a task bar area 320 may be changed to correspond to the logo associated with the communicator program that generated the alert.

In one embodiment, clicking on an active area of the alert window 300 will open the communicator interface associated with the corresponding communicator program. For example, the logo display 310 or the associated headline may be active areas of the alert window 300. In other embodiments, a drop-down list may be used to select the program according to a method described below.

FIG. 4 illustrates one embodiment of a screen shot of a drop-down list.

In some embodiments, the user can select one of several communicator programs in a drop-down list of communicator programs. A drop-down list may be used to specify the sequence of communicator programs that are received by the communicator program manager.

In the illustrated embodiment, a drop-down list 400 is opened by right-clicking the mouse on a communicator task bar icon 440 in a task bar area 450. The drop-down list 400 presents at least some of the available communicator programs. A scroll-up button 425 and a scroll-down button 430 can be used to scroll the drop-down list 400 to show portions of the list of communicator programs above or below the displayed portion of the list.

A selection marker 405 indicates the currently selected communicator program and a highlight bar 410 highlights the communicator program that will be selected should the user left-click a mouse, for example. The highlight bar 410 can be moved using the mouse. Other methods of specifying the selected communicator program may be used.

A control area 420 of the drop-down list 400 may allow for control of the communicator program manager. For example, the user may specify that this communicator program manager should be launched each time the computer starts up. The user may be able to initiate a process whereby some or all of the communicator programs check for updated content from the corresponding information sources. The user may also be able to initiate a process whereby a check for an updated version of the communicator program manager is performed. Furthermore, the user may be able to control how the communicator programs are sequenced. For example, the user may specify that the communicator program manager should sequence through the communicator programs based on a predetermined time interval or after presented the new information, if any, associated with that communicator program.

FIG. 5 illustrates another embodiment of a screen shot of a drop-down list.

In the illustrated embodiment, a drop-down list 500 is opened by right-clicking the mouse on a communicator interface 505. In this illustration, the communicator interface 505 is partially obscured by the drop-down list 500 in the foreground. Jdrop-down list 500 contains all or a portion of the available communicator programs. A scroll-up button 525 and a scroll-down button 530 are used to scroll the drop-down list 500 to show portions of the list of communicator programs above or below the displayed portion of the list.

A selection marker 510 indicates the currently selected communicator program and a highlight bar 535 highlights the communicator program that will be selected should the user right-click the mouse. The highlight bar 535 can be moved using the mouse. Other methods of specifying the selected communicator program may be used. A control area of the drop-down list 500 may allow for control of the communicator program manager.

FIG. 6 illustrates another embodiment of a communicator interface for an associated communicator program configured to display podcast information. In the illustrated embodiment, a communicator interface 600 is displayed along with a podcast menu 620 and a menu window 610.

The podcast menu 620 contains a podcast window 630, a podcast window 640, a podcast window 650, a podcast window 660, and a podcast window 670. Each of the podcast windows include a text based title corresponding to that podcast. A user may select the podcast by clicking on an active area of that podcast window. In some embodiments, a podcast control 680 is displayed when the podcast is selected. The podcast control 680 enables playback control of the selected podcast. The menu window 610 may allow for selecting various categories of information and/or searching the information associated with the communicator program.

FIG. 7 illustrates another embodiment of a communicator interface for an associated communicator program configured to display streaming video information. In the illustrated embodiment, a communicator interface 700 is displayed along with a streaming video menu 720 and a menu window 710.

The streaming video window contains a streaming video menu 730, a streaming video window 740, a streaming video window 750, a streaming video window 760 and s streaming video window 770. Each of the streaming video windows includes a text based title corresponding to that streaming video. A user may select the streaming video by clicking on an active area of that streaming video window. In some embodiments, a streaming video control is displayed when the streaming video is selected. The streaming video control enables playback control of the selected streaming video. The menu window 710 may allow for selecting various categories of information and/or searching the information associated with the communicator program.

FIG. 8 illustrates another embodiment of a communicator interface for an associated communicator program configured to present text-based news. In the illustrated embodiment, a communicator interface 800 is displayed along with a news menu 820 and a menu window 810.

The news menu contains a menu item 830, a menu item 840, a menu item 850, a menu item 860, and a menu item 870. Each of the menu item windows includes a text based title and the leading part of the text corresponding to that menu item. A user may select the menu item by clicking on an active area of that menu item. When the menu item is selected the full news story is presented. The menu window 810 may allow for selecting various categories of information and/or searching the information associated with the communicator program.

FIG. 9 illustrates another embodiment of a communicator interface for an associated communicator program configured to present ticker information. In the illustrated embodiment, a communicator interface 900 is displayed. The communicator interface 900 includes a logo 910, a menu button 920, a menu button 930, a menu button 940, a menu button 950, a menu button 960, and a ticker display 970. A state button 905, a previous button 980, a close button 985, and a next button 990 are also displayed.

In the illustrated embodiment, five menu buttons are presented. The menu buttons may be used to select various categories of information for presentation. In some cases, one or more additional menus are presented after selecting a menu button. For example, the menu button 920 is labeled “blogs” and is configured to present a list of specific blog entries when selected. The user may then select one of the blog entries for presentation.

The ticker display 970 is configured to display the new information, if any, for each communicator program. The new information is sequenced from each communicator program according to the communicator program sequence. The sequenced information then displays across the ticker display from beginning to end. In some embodiments, the ticker content is updated periodically. For example, the text corresponding to one of the communicator programs may be replaced with new information. Furthermore, some text may be removed from the ticker display when it is no longer considered new. In some embodiments, new is defined by the information source that published the information. The information source can tag the information as new, or specify how long that information should be considered new. In some embodiments, the communicator program determines what is considered new information For example, information may be considered new for a predetermined amount of time since it was published by the information source. In other embodiments, information may be considered new for a predetermined amount of time since that information was first presented by the communicator program even though it might have been published by the information source before that.

In some embodiments, the ticker display can be controlled using a previous button 980 or next button 990 to specify the subsequently displayed information relative to the position of the currently displayed information corresponding to the ordered list of communicator programs. In response to clicking the previous button 980, the communicator program starts presenting the information corresponding to the communicator program immediately preceding the currently selected communicator program in the ordered list. In response to clicking the next button 990, the communicator program starts presenting the information corresponding to the communicator program immediately following the currently selected communicator program in the ordered list. In some embodiments, the sequence wraps around such that the first communicator program in the ordered list immediately follows the last communicator program and the last communicator program in the ordered list immediately precedes the first communicator program.

The close button 985 is used to close the ticker window 900. The state button 905 is used to transition between two communicator interface formats. For example, when a user clocks on the state button 905, the format of the communicator interface 900 may change to one similar to the communicator interface 200 shown in FIG. 2. The user may clock on a state button in the alternative communicator interface to switch back to the communicator interface 900.

FIG. 10 illustrates another embodiment of a communicator interface for an associated communicator program. In the illustrated embodiment, a communicator interface 1000 is displayed along with a menu 1020 and a menu window 1010.

The news menu contains menu items. Each of the menu items includes a description corresponding to that menu item. A user may select the menu item by clicking on an active area of that menu item. When the menu item is selected the corresponding action is taken. For example, the new menu, streaming audio menu or streaming video menu may be displayed as described herein. The menu window 1010 may allow for selecting various categories of information and/or searching the information associated with the communicator program.

FIG. 11 shows a diagrammatic representation of an embodiment of a machine 1100 within which a set of instructions, for causing the machine to perform any one or more of the methodologies discussed herein, may be executed. The machine may be connected (e.g., networked) to other machines. In a networked deployment, the machine may operate in the capacity of a server of a client machine in an client-server network environment, or as a peer machine in a peer-to-peer (or distributed) network environment. In one embodiment, the machine communicates with the server to facilitate operations of the server and/or to access the operations of the server.

The machine 1100 includes a processor 1102 (e.g., a central processing unit (CPU) or a graphic processing unit (GPU) or both), a main memory 1104, and a nonvolatile memory 1106, which communicate with each other via a bus 1108. In some embodiments, the machine 1100 may be a handheld positioning device, a laptop computer, personal digital assistant (PDA) or mobile phone, for example. In one embodiment, the machine 1100 also includes a video display 1130, an alphanumeric input device 1132 (e.g., a keyboard), a cursor control device 1134 (e.g., a mouse), a microphone 1136, a disk drive unit 1116, a signal generation device 1118 (i.e., a speaker), and a network interface device 1120 coupled to a network 1140.

In one embodiment, the video display 1130 includes a touch sensitive screen for user input. In one embodiment, the touch sensitive screen is used instead of a keyboard and mouse. The disk drive unit 1116 includes a machine-readable medium 1122 on which is stored one or more sets of instructions (e.g., software 1122) embodying any one or more of the methodologies or functions described herein. The software 1124 may also reside, completely or at least partially, within the main memory 1104 and/or within the processor 1102 during execution thereof by the computer system 1100, the main memory 1104, and the processor 1102 also constituting machine-readable media. The software 1124 may further be transmitted or received over a network 1140 via the network interface device 1120.

An alternate embodiment of the invention is illustrated in FIGS. 12 to 17.

FIGS. 12 and 13 illustrate the creation of an alert channel in accordance with the invention. The computer system of a channel owner is illustrated in FIG. 12 and includes a computer and a keyboard (or other means) to input data and control commands in the computer. The computer includes controller 12 and memory 17. Controller 12 includes control 13 and a computer operating system sub-routine 14A which utilizes data 16A from memory 17. The channel owner uses the computer system of FIG. 12 to access the Internet 27 and contact the alert central computer 100 illustrated in FIG. 13. After the channel owner contacts the alert central computer, the channel owner opens an account 31 at the alert central computer. The channel owner selects a user name, which can for example, be an e-mail that the channel owner utilizes; and, selects a password. The channel owner can subsequently utilize his user name and password to access his account at the alert central computer 100. After an account is opened, the channel owner downloads from the alert central computer via the Internet 27 the alert computer application to his desktop computer 12, 17; creates an independent alert channel 33 at the central computer 100; and, sends an e-mail to friend A's iPhone 34 inviting friend A to join the alert channel. The channel owner also accesses the central computer 100 with his iPhone and downloads the alert application to his iPhone. The channel owner also utilizes a plug-in which will, if the channel owner elects, transmit an alert to the Facebook (SM) server 25 (FIG. 17) to be posted on the channel owner's Facebook page.

FIGS. 14 and 15 illustrate the creation of an account by the channel user's friend A. FIG. 14 illustrates the computer in the iPhone 34 of the channel owner's friend A. The computer includes a controller 34A and a memory 34B. The controller 24A includes a control 13 and a computer operating system sub-routine 14A which utilizes data 16A from memory 34B. The friend's iPhone receives via the Internet the channel owner's invitation 43 to join the channel owner's channel. Friend A contacts via Internet 27 the alert central computer 100 illustrated in FIG. 15. Friend A opens an account 35 at the central computer 100. Friend A selects a user name, which can for example, be an e-mail that the channel owner utilizes; and, selects a password. Friend A can subsequently utilize his user name and password to access his account at the alert central computer 100. Friend A downloads the alert app to iPhone 34, and while communicating with central computer 100 accepts 37 the channel owner's invitation to become a member of the channel owner's alert channel. Friend A also accesses central computer 100 with his laptop computer and downloads the alert computer application to his laptop computer. Friend A also utilizes a plug-in which will, if Friend A elects, transmit an alert which Friend A receives to the Facebook (SM) server 25 (FIG. 17) to be posted on the Facebook page of Friend A.

The generation and transmission of an alert message is illustrated in FIGS. 16 and 17. In FIG. 16, the channel owner utilizes keyboard 10 to input into controller 12 an alert message. The alert message can comprise any desired message, but for example, the message can indicate that a highway is closed due to an accident, that inclement weather is expected, that an individual has been taken to the hospital, that the starting time of a baseball game has changed, etc.

In an alternate embodiment of the invention, the channel owner uses his desktop computer (or iPhone) to contact via the Internet the central computer 100 and composes the alert message directly into or at the central computer for simultaneous transmission to an iPhone, an Android, an iPad, Facebook, Utube, etc.

The alert message 11 is transmitted with IP (Internet protocol) to the central computer 100. Central computer 100 simultaneously transmits with IP (Internet protocol) the alert message to the “push” server 28 of the vendor (i.e., Apple) for the iPhones 24 and 27, to the Facebook server 25, and into Friend A's account and the channel owner's account at central computer 100 for access 26, 30 by Friend A's laptop and the channel owner's laptop, respectively.

The central computer 100 utilizes a mobile phone interface 21 provided by the vendor server 28 to communicate with server 28.

The central computer 100 utilizes an interface 22 provided by Facebook to communicate with server 25.

The central computer 100 utilizes a laptop interface 23 which permits central computer to communicate via the Internet with laptop (or desktop) computers.

Server 28 is a “push” server which will immediately transmit the alert message via one or more cell towers or other transmission stations to the iPhones™ 24, 27 and cause the alert message, or a prompt that an alert message has been received and can be read, to appear on the display screen of each iPhone™ 24, 27 (or Android™ or iPad™) or other device with “push” reception capability.

Facebook™ server 25 also has the capability to immediately transmit an alert message to the Facebook™ account 28, 29 of Friend A or the channel owner, respectively.

Laptops 26, 30 are “pull” devices which must be turned on and which must access via Internet 27 central computer 100 in order to receive the alert message composed by the channel owner.

When the channel owner creates an alert channel, the channel owner can elect to make the channel private, in which case the channel is not public and can not be located by an Internet search engine. A private channel is only accessible by unauthorized individuals if the individuals successfully “hack” into central computer 100 and then into the private channel of the channel owner.

In addition, when the channel owner creates an alert channel, the channel owner can select and activate a variety of features including “Reply to only Owner”, “Allow Specific User”, “Allow Public Reply”, “Allow Sending Alerts”, “Reply to Sender Only”, “Allowing Sharing”, “Allow Public to Post”, “Post Go to Owner Only”, “Show Posted By”, “Allow Sending Alerts for Reply”, “CC Post to CoOnwers”, “CC Reply to Co Owners”.

While the machine-readable medium 1122 is shown in an exemplary embodiment to be a single medium, the term “machine-readable medium” should be taken to include a single medium or multiple media (e.g., a centralize or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies. The term “machine-readable medium” shall accordingly be taken to include, but not be limited to, solid-state memories, optical and magnetic media, and carrier wave signals.

In general, the routines executed to implement the embodiments of the disclosure may be implemented as part of an operating system or a specific application, component, program, object, module or sequence of instructions referred to as “programs.” For example, one or more programs may be used to execute specific processes described herein. The programs typically comprise one or more instructions set at various times in various memory and storage devices in the machine, and the, when read and executed by one or more processors, cause the machine to perform operations to execute elements involving the various aspects of the disclosure.

Moreover, while embodiments have been described in the context of fully functioning computers, those skilled in the art will appreciate that the various embodiments are capable of being distributed as a program product in a variety of forms, and that the disclosure applies equally regardless of the particular type of machine or computer-readable media used to actually effect the distribution. Examples of machine-readable media include but are not limited to recordable type media such as volatile and non-volatile memory devices, floppy and other removable disks, hard disk drives, optical disks (e.g., Compact disk Read-Only Memory (CD ROMS), Digital Versatile Disks, (DVDs), etc.), among others, and transmission type media such as digital and analog communication links.

Although embodiments have been described with reference to specific exemplary embodiments, it will be evident that various modifications and changes can be made to these embodiments. Accordingly, the specification and drawings are to be regarded in an illustrative sense rather than in a restrictive sense. The foregoing specification provides a description with reference to specific exemplary embodiments. It will be evident that various modifications may be made thereto without departing from the broader spirit and scope as set forth in the following claims. The specification and drawings are, accordingly, to be regarded in an illustrative sense rather than a restrictive sense.

Moreover, while embodiments have been described in the context of fully functioning computers, those skilled in the art will appreciate that the various embodiments are capable of being distributed as a program product in a variety of forms, and that the disclosure applies equally regardless of the particular type of machine or computer-readable media used to actually effect the distribution. Examples of machine-readable media include but are not limited to recordable type media such as volatile and non-volatile memory devices, floppy and other removable disk drives (e.g., Compact Disk Read-Only Memory (CD ROMS), Digital Versatile Disks, (DVDs), etc.), among other, and transmission type media such as digital and analog communication links.

Although embodiments have been described with reference to specific exemplary embodiments, it will be evident that the various modification and changes can be made to these embodiments. Accordingly, the specification and drawings are to be regarded in an illustrative sense rather than in a restrictive sense. The foregoing specification provides a description with reference to specific exemplary embodiments. It will be evident that various modifications may be made thereto without departing from the broader spirit and scope as set forth in the following claims. The specification and drawings are, accordingly, to be regarded in an illustrative sense rather than a restrictive sense.

Having described my invention in such terms as to enable those skilled in the art to understand and practice it, I claim:

1. A secure communication system comprising
(a) a first central server connected to the Internet to transmit messages over the Internet utilizing IP protocol;
(b) at least one push device with a display screen, the push device selected from a group consisting of mobile phones and computer tablets configured to function in part as a mobile phone;
(c) at least one pull device commonly owned with the push device, connected to the Internet and selected from a group consisting of laptop computers and desk top computers;
(d) at least one cell phone tower to receive a push alert message and transmit the push alert message to the push device for display on the display screen of the push device;
(e) a vendor server connected to the Internet and in communication with the cell tower to receive an alert message generated by the first central server and generate a push alert message to transmit to the cell tower for transmission to the push device to appear on the display screen of the push device;
(f) a channel architecture on the first central server comprising a plurality of different channels each
(i) independently created by a different subscriber, and
(ii) operable independently of the other channels,
at least one of the channels being a private channel that is
(iii) configured to generate simultaneously a selected alert message for both the vendor server and the pull device, said selected alert message being transmitted by the first central server over the Internet using IP protocol to the vendor server and the pull device,
(iv) non-published,
(v) accessible only through the first central server by the subscriber of the channel, and
(vi) non-identifiable and non-locatable using an Internet search engine.
